(19) United States
(12) Patent Application Publication
(10) Pub. No.: US 2006/0085333 A1
(43) Pub. Date: Apr. 20, 2006

(54) Credit/debit card payment system

(76) Inventors: Leow Onn Wah, Singapore (SG); Ng Peng Chuan Adrian, Singapore (SG); Ng Lim Hing Patrick, Singapore (SG)

Correspondence Address: Mark Manley, 5205 W 32nd, Sedalia, MO, 65301, US

(21) Appl. No.: 10/926,580

(22) Filed: Aug. 25, 2004

(51) Int. Cl. G06Q 40/00

(52) U.S. Cl. 705/40

(57) ABSTRACT

A system providing a payment transaction using a single selection from a plurality of credit/debit card accounts without requiring the use of any corresponding credit/debit card. The system uses a unique customer identity number associated with a plurality of credit/debit card accounts. The system also provides the retrieval of transaction history as well as the retrieval of promotional information and product information.

### CROSS-REFERENCE TO RELATED APPLICATIONS

Not Applicable

### FEDERALLY SPONSORED RESEARCH

Not Applicable

### SEQUENCE LISTING OR PROGRAM

Not Applicable

### FIELD OF THE INVENTION

This invention relates to a system for making credit/debit card payment transactions from a choice of credit/debit card accounts at a point-of-sale by using a single customer identity number and without the necessity of having any credit/debit cards physically present.

### BACKGROUND OF THE INVENTION

Recently, it has become common practice for a customer, consumer, shopper, purchaser and the like to concurrently possess a multitude of credit cards, debit cards, rewards points cards, stored-value cards and the like from different banks and credit/debit card issuing bodies. It is common practice for such customer to personally carry all or most of such cards so as to provide himself or herself with the option of using any one card of his or her choice when making a payment transaction.

When credit/debit cards are physically carried, a customer runs the risk of misplacing and losing his or her credit/debit cards or having said cards being stolen. The reporting of lost cards is a troublesome, inconvenient and often stressful process, as the customer would have to inform the relevant credit/debit card company of the loss and in certain circumstances, would have to report the loss to the police and the like. Further, while the customer awaits a replacement, said customer is unable to utilize said lost credit/debit cards.

Often, due to high competition, banks and credit/debit card issuing bodies would provide promotional offers, such as discounts, attractive initiation fees or attractive financing rates in order to encourage the use of a specific type of credit/debit card. Often, there would be promotions and offers for specific types of credit/debit cards when used in specific stores, restaurants, shops and the like. As an example, the customer may be rewarded with a ten percent discount on his or her bill in XYZ restaurant if credit card A is used, but not if credit card B is used. As said, promotions and offers are often for a limited period and are constantly changing, it is difficult to keep track of all the promotions and offers existing in relation to each credit/debit card.

When making a payment transaction at a store, shop, restaurant or the like, it is common practice for a customer to ask the service staff if the use of any of the customer's credit/debit cards would result in a discount or a greater level of rewards points. Making such request is often time-consuming and troublesome; service staff may not always be available to indicate the most advantageous credit/debit card to use, further, service staff may not always be aware of the most advantageous credit/debit card to use and may have to spend time finding out whether a discount or reward would result from the use of a specific type of credit/debit card.

U.S. Pat. No. 6,685,088 to Royer et al (2004) discloses a system that allows a plurality of accounts to be accessed from a single selecta-card by using a card reader and associating each account with a pre-assigned account identification number; a user of such system would have to remember each account identification number assigned. This is an inconvenience and is impractical. Further, although the risk of losing one's credit/debit cards is reduced, the invention does not eliminate the risk of losing one's selecta-card.

U.S. Pat. No. 6,341,724 to Campisano (2002) discloses an invention that associates a single telephone number to a pre-selected credit/debit card account for a cardless payment transaction, but does not allow the user to conveniently select which credit/debit card account to use at the point of purchase and at the time of purchase.

U.S. Pat. No. 6,467,684 to Fite et al (2002) discloses a pre-paid card system in which stored value cards must be pre-purchased before use in transactions over the internet, such cards being for one-time use only. This requires the additional steps of pre-purchasing cards every time credit is depleted and requires the user to carry such pre-purchased cards.

U.S. Pat. No. 6,282,522 to Virgil et al (2001) discloses a system enabling payment of goods/services over the Internet using a smart card and a smart card reader. In contrast, in one embodiment of the present invention, there is no need for any card reader to be present when making payments over the Internet.

As can be seen, there is a need for a credit card payment system that will minimize the risk of lost cards by eliminating the need to physically carry the cards. Further, there is a need for a payment system that maximizes a person's payment options across a variety of transactions.

### SUMMARY OF THE INVENTION

An objective of the present invention is to eliminate the potential risks and drawbacks of a customer having to physically carry numerous credit cards, debit cards, rewards points cards, stored-value cards and the like with him or her when wanting to make a purchase at a store. This is accomplished by enabling the customer to make payments from such credit/debit card accounts by using a single unique customer identity number and without the need for such credit/debit cards to be physically present. This would eliminate any risks of said credit/debit cards being lost, misplaced or stolen as such cards need not be brought along with the customer. This would also eliminate the inconvenience of having to replace such credit/debit cards should they be lost, misplaced or stolen.

The present invention also enables the customer to choose which credit/debit card accounts to use for payment at the point of purchase.

The present invention provides the customer with the convenience of retrieving relevant transaction history pertaining to his or her credit/debit card accounts at the point of purchase.

A further object of the present invention is to reduce the need for a customer to remember the approximate balance of credit, points, rewards points, stored-value and the like remaining in each credit/debit card account by providing the customer with convenient access to the total level of credit and the like already used over a specific period of time. Further, where the customer has provided information pertaining to the limit of credit and the like for a credit/debit card account, the present invention may provide a calculated balance of the credit and the like remaining within said account. In this way, the customer is properly informed as to the balance and is assisted in avoiding any inconvenience or embarrassment should the customer try to use a credit/debit card account with insufficient credit and the like for the transaction.

The present invention provides the customer with the opportunity to make informed choices with regard to which credit/debit card account to use when making a payment transaction. This is accomplished by providing to the customer relevant product information and promotional information as well as informing the customer of discounts, offers and rewards offered, if any.

Further, the present invention does not require each account to be assigned an account identification number; furthermore, the present invention does not require the inconvenience of having to carry and use a card in order for a plurality of accounts to be accessed.

### DRAWINGS—FIGURES

FIG. 1 is a block diagram showing a system configuration of the invention.

FIG. 2 is a flowchart showing a method of entering customer information and a method of obtaining a customer identity number.

FIG. 2A is a flowchart showing a method of entering and storing credit/debit card account information.

FIG. 3 is a flowchart showing a method of updating customer information and credit/debit card account information.

FIG. 4 is a flowchart showing a method of authenticating customer identity number and customer password.

FIG. 5 is a flowchart showing a method of making a payment transaction from a store terminal.

FIG. 6 is a flowchart of retrieving transaction history.

FIG. 7 is a flowchart of storing promotional information.

FIG. 8 is a flowchart of retrieving promotional information.

FIG. 9 is a flowchart showing a method of automatically filling in a purchase form with customer information and credit/debit card information.

### DETAILED DESCRIPTION OF THE PREFERRED EMBODIMENTS

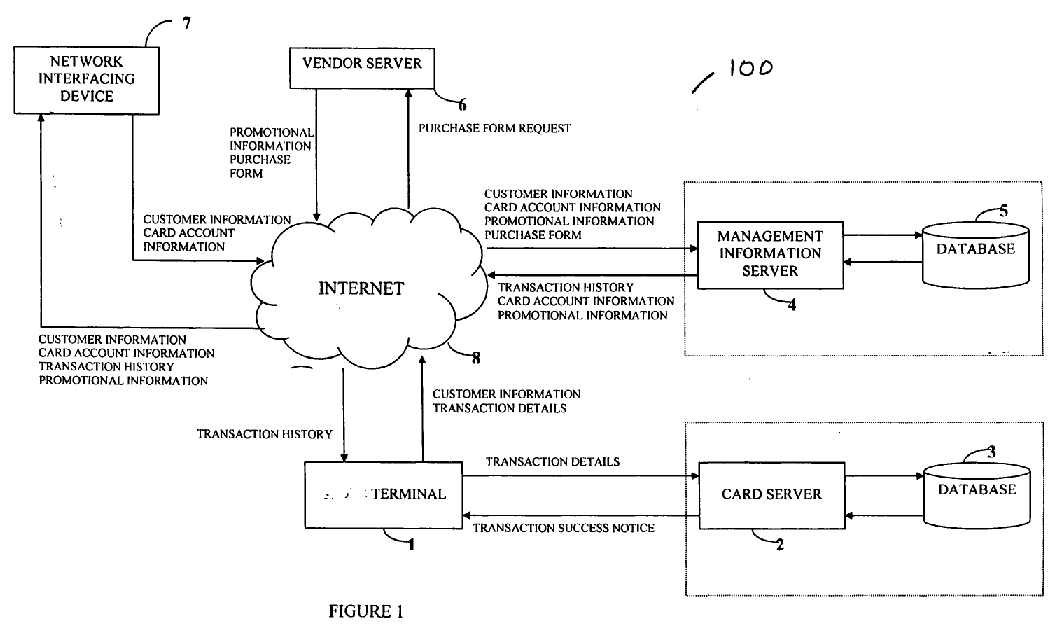

FIG. 1 is a diagram showing a system 100 configuration of the invention. In FIG. 1, reference number 4 is an network interfacing device and includes any computer, interconnected computers, terminal, interconnected terminals, portable electronic handheld device, mobile phone device, electronic device, software, web browser, file transfer program and any combination of the foregoing with a connection to the internet, such connection includes any connection through any network, telephone line, radio connection, infra-red connection, wireless connection and any connection enabling the transfer of data.

Reference number 1 is a terminal such as a store or network terminal and can include any computer, terminal, workstation, interconnected computers, terminals and workstations, visual display unit, kiosk, electronic device and any combination of the foregoing. Terminal 1 can be physically located at or near a shop, retail store, outlet or any place in which goods/services are sold and credit/debit cards are accepted methods of payment. Further, terminal 1 is connected to card server 2, the connection includes a direct connection, indirect connection, connection through a network, connection through any device that processes credit/debit card transactions, and any combination of the foregoing.

Within this description, database 3 includes any database, any set of databases, any interconnected databases, any data storage device, and any combination of the foregoing directly or indirectly connected to management information server 4.

Within this description, the term customer identity number includes any alphanumeric sequence of alphabets, digits and symbols, digital certificate, digital signal, analogue signal, and any identifier/indicia suitably configured to allow the customer to interact or communicate with the system, and any combination of the foregoing.

Within this description, the term customer information includes the customer's name, the customer's residential address, the customer's date of birth, the customer's social security number, any other personal information pertaining to the customer and any combination of the foregoing.

Within this description, the term card account information includes the credit/debit/rewards/stored value card number, expiration date, name of card holder, card issuer, affiliation, payment platform, and any information pertaining to said card account, and includes the foregoing in relation to a plurality of credit/debit card accounts, and any combination of the foregoing.

Within this description, the term debit/credit card includes any credit card, debit card, rewards points card, stored value card and the like and any combination of the foregoing.

Within this description, the term internet includes any network, data network, set of interconnected networks, and any combination of the foregoing.

Within this description, the term promotional information includes promotional offers, special offers, general and seasonal offers, rewards offers, product information and updates, service information and updates, advertising information and any combination of these and links to any combination of these.

Within this description, any reference to the provision of data by the customer includes manually keying in such data through a keyboard, keypad, touch sensitive screen, pointing device such as a mouse and trackball and joystick, reading a magnetic strip card, reading a smart card, reading a memory device, and any method of data input and data transfer and any combination of these methods.

Within this description, the sending and receiving of data/information includes the sending and receiving of any data in any format, including as a web page, XML format, any file transfer protocol, email, text messaging, any data packet protocol, network protocol and the like.

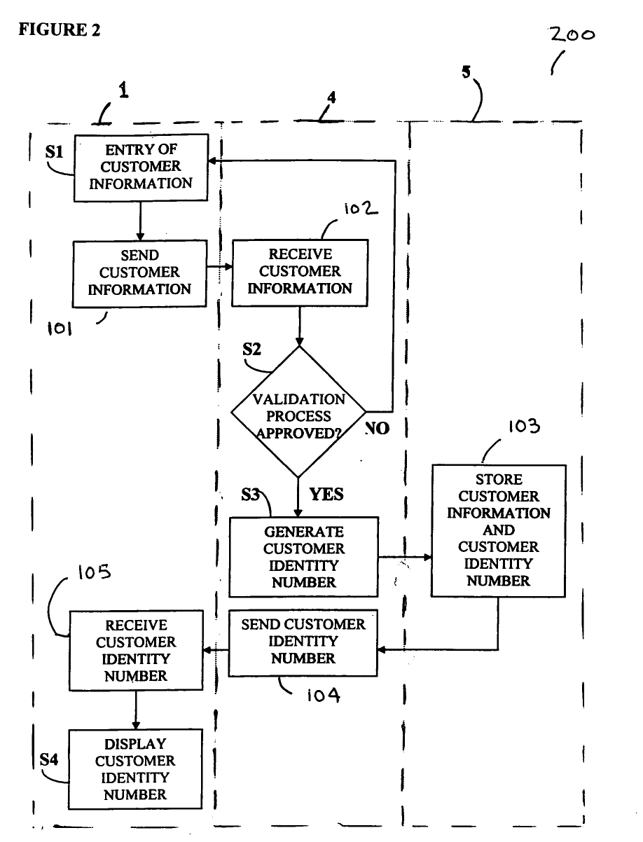

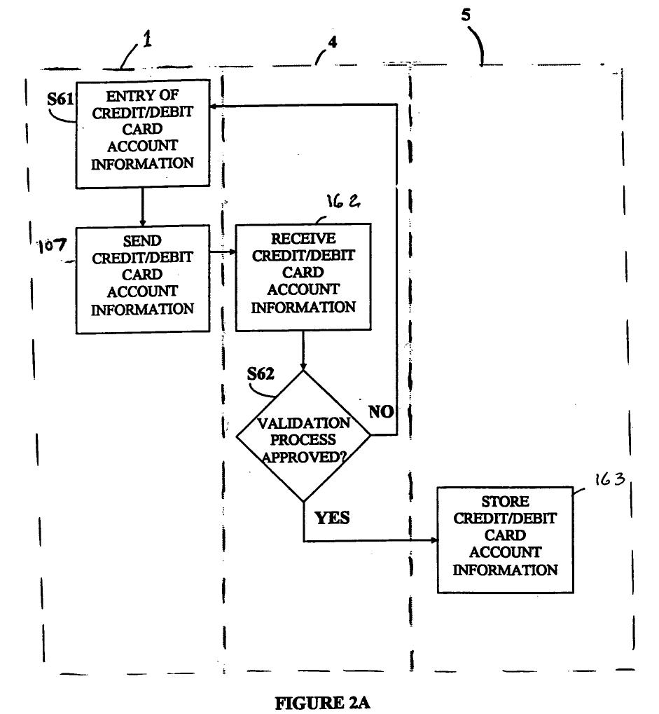

FIG. 2 shows one method 200 of obtaining a customer identity number. In FIG. 2 dashed lines indicate terminal 1, server 4 and database 5 shown relationally in FIG. 1. In step S1, from terminal 1, which can be a store terminal or network interfacing device, the customer provides customer information by a method of data input or data transfer, including data entry onto a web page form and file transfer. Subsequently, customer information is sent 101 from network interfacing device or terminal 1 to management information server 4, where customer information is received 102 and validated in step S2. This validation S2 may be performed through the sending of a web page, XML format, email, and any format by which data can be sent and received.

The process of validation in step S2 includes verifying that all required data formats and data sequence requirements are adhered to, specific data conforms with data on look-up tables, numeric data requirements are adhered to, and any combination of the foregoing. If validation requirements are not passed, then validation is not approved in step S2 and step S1 is returned to, where the customer is provided with further opportunity to enter correct customer information.

If validation requirements are passed, then validation is approved in step S2, and a unique customer identity number is generated in step S3. Subsequently, said customer information and generated unique customer identity number are stored 103 on database 5. Further, said customer identity number is sent 104 from management information server 4 to terminal 1, as the case may be, where said customer identity number is received 105 and displayed in step S4.

FIG. 2A shows a method of entering and storing credit/debit card account information. In FIG. 2a dashed lines indicate terminal 1, server 4 and database 5 shown relationally in FIG. 1. In step S61, terminal 1, the customer provides credit/debit card account information by a method of data input or data transfer, including data entry onto a web page form and file transfer. Subsequently, credit/debit card account information is sent 107 from terminal 1 to management information server 4, where customer information is received 162 and validated in step S62.

The process of validation in step S62 includes verifying that all required data formats and data sequence requirements are adhered to, specific data conforms with data on look-up tables, numeric data requirements are adhered to, and any combination of the foregoing. If validation requirements are not passed, then validation is not approved in step S62 and step S61 is returned to, where the customer is provided with further opportunity to enter correct credit/debit card account information.

If validation requirements are passed, then validation is approved in step S62, and credit/debit card account information is stored 163 on database 5.

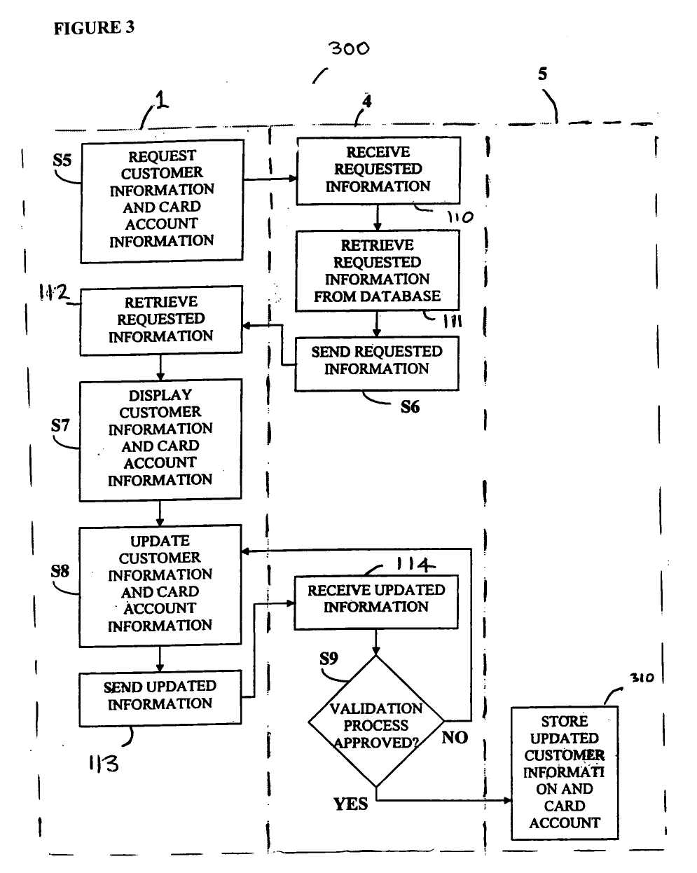

FIG. 3 shows one method 300 of retrieving and updating customer information and card account information. In FIG. 3 dashed lines indicate terminal 1, server 4 and database 5 shown relationally in FIG. 1. In step S5, from terminal 1, the customer requests for customer information and card account information.

The management information server 4 receives 110 such request and retrieves 111 said customer information and credit/debit card account information from database 5. In step S6, said customer information and card account information is sent from management information server 4 and received 112 by network interfacing device 7 or store terminal 1, as the case may be, which then displays the received information in step S7.

In step S8, the customer is provided with an opportunity to amend and update said customer information and card account information. The amended customer information and/or said amended card account information is sent by the terminal 1, as the case may be, and received 114 by management information server 4. Subsequently, in step S9, said amended customer information and/or said amended card account information is checked and validated.

The method of validating customer information in step S9 is identical to that described above in step S2, that is, verifying that all required data formats and data sequence requirements are adhered to, verifying that specific data conforms with data on look-up tables, verifying that numeric data requirements are adhered to, and any combination of the foregoing. If validation requirements are not passed, then validation is not approved in step S9 and step S8 is returned to, where the customer is provided with further opportunity to enter correct customer information.

The method of validating card account information in step S9 can include validating any check digits within credit/debit card number, validating any confirmation numbers or check numbers associated with said credit/debit card, verifying that all required data formats and data sequence requirements are adhered to, verifying that specific data conforms with data on look-up tables, verifying that numeric data requirements are adhered to, and any combination of the foregoing.

If validation requirements are passed, then validation is approved in step S9 and the amended customer information as well as the amended card account information is stored on database 5.

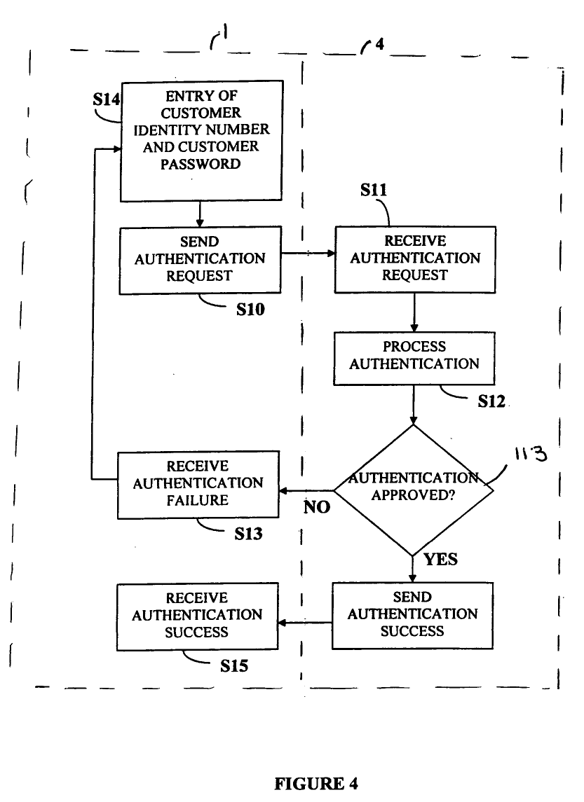

FIG. 4 is a flow diagram showing a method 400 for authenticating said customer identity number and said customer password. In FIG. 4 dashed lines indicate terminal 1, and server 4 shown relationally in FIG. 1.

A customer provides a unique customer identity number and a customer password. The customer can perform this at store terminal 1 as well as network interfacing device 7. A request for authentication is then sent S10 to management information server 4.

Upon receiving such request for authentication S11, management information server 4 attempts to authenticate the customer identity number and customer password in step S12.

A method for performing such authentication S12 is by searching through records of the relevant data fields on database 5. If an identical customer identity number is found on a record with corresponding identical customer password, then authentication is successful, otherwise, authentication is unsuccessful.

If authentication 113 is unsuccessful S13, the management information server 4 sends a message to store terminal 1 through the internet 8 that authentication is unsuccessful. Upon receiving the message that authentication is unsuccessful, store terminal 1 displays a message informing the customer that such authentication is unsuccessful and does not allow any further transaction to be made at such time. Step S14 is then repeated and a valid customer identity number and customer password combination is required to be entered.

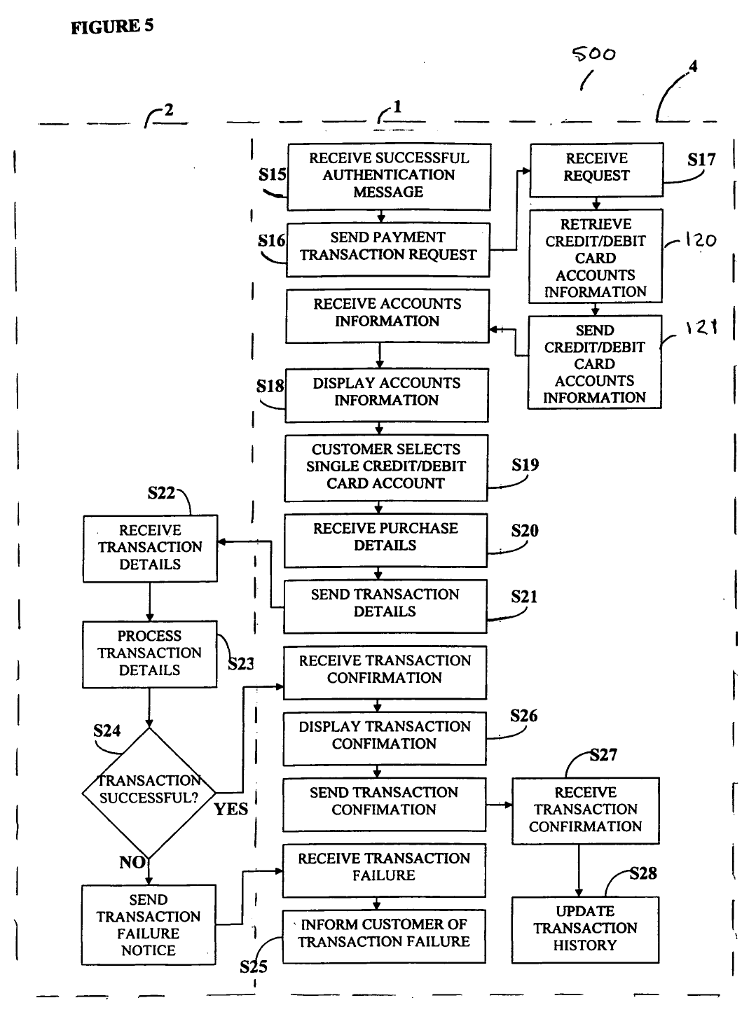

FIG. 5 is a flow diagram showing a method 500 for making a payment transaction from a store terminal 1 using a selected credit/debit card account without the need for such credit/debit card to be physically present. In FIG. 5 dashed lines indicate terminal 1, server 4 and card server 2 shown relationally in FIG. 1.

If authentication is successful S15, terminal 1 sends a payment transaction request to management information server 4 in steps S16 and S17. Subsequently, management information server 4 retrieves 120 from database 5 the credit/debit card accounts information associated with the customer identity number, such credit/debit card accounts information previously provided. The management information server 4 then sends 121 to terminal 1 through the internet 8 said credit/debit card accounts information.

In step S18, terminal 1 then displays a list of credit/debit card accounts related to the customer and requests for a selection to be made as to which credit/debit card account is to be used in making the payment transaction. In step S19, a selection is made as to which credit/debit card account is to be used in making the payment transaction.

In step S20, purchase details can mean purchase transaction amount and can mean any information relating to the purchase transaction, such as the goods/services to be purchased, the respective prices for such goods/services and quantity to be purchased. A conventional method to perform step S20 is for a service staff of the store to key in such purchase details. A further conventional method is for a machine to read a barcode associated with the good/service and subsequently retrieve the price and other information from a database.

In steps S21 and S22, transaction details are sent by terminal 1 and received by card server 2. The transaction details includes the selected credit/debit card account number and expiration date, name of holder of said selected credit/debit card account, total amount of transaction, currency of transaction, date and time at which transaction is attempted, registration number of the store according to the records of the payment platform company, and any information related to the payment transaction, and any combination of the foregoing.

In step S23, transaction details are processed by card server 2. This is a process internal to the credit/debit card company managing such transaction.

In step S24, if the transaction is unsuccessful, then a transaction failure notice is sent to store terminal 1 and said notice is displayed accordingly in step S25.

In step S24, if the transaction is successful, then a transaction success notice is sent to store terminal 1 and said notice is displayed accordingly in step S26. Subsequently, transaction details and notice of transaction success is sent to management information server 4 in step S27. Subsequently, said transaction details and notice of transaction success are stored S28 on database 5 as transaction history associated with said customer identity number.

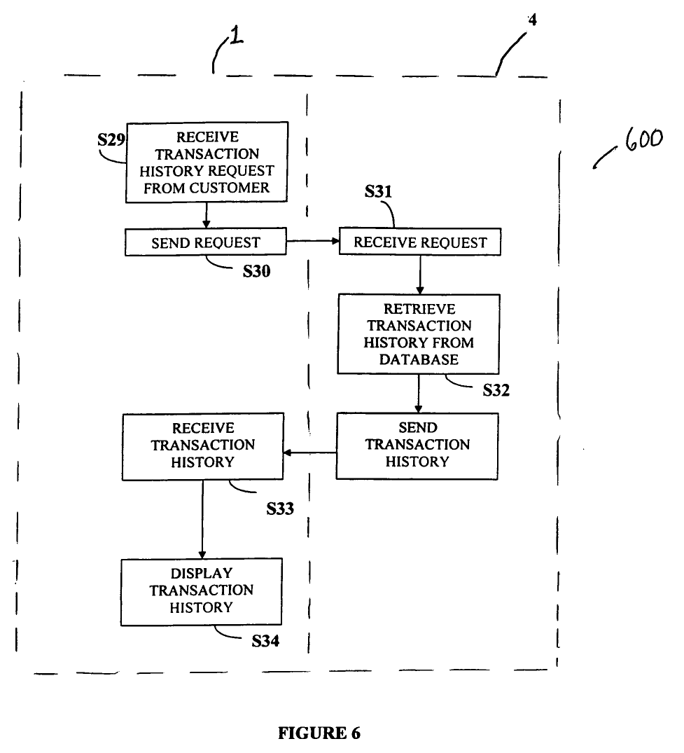

FIG. 6 shows a method 600 for retrieving and displaying a customer's transaction history. In FIG. 6 dashed lines indicate terminal 1, and server 4 shown relationally in FIG. 1. In step S29, store terminal 1 receives a request for transaction history from customer. Subsequently, in step S30, store terminal 1 sends a request for transaction history to management information server 4. In a further embodiment not shown, in step S29, network interfacing device 7 receives a request for transaction history from customer; subsequently, in step S30, network interfacing device 7 sends a request for transaction history to management information server 4.

Management information server 4 receives said request in step S31 and subsequently retrieves transaction history from database 5 in step S32.

Management information server 4 then sends said transaction history to store terminal 1 where said transaction history is received and displayed to customer in step S34. In a further embodiment, management information server 4 sends said transaction history to network interfacing device 7 where it is received by network interfacing device 7 in step S33 and displayed to customer in step S34.

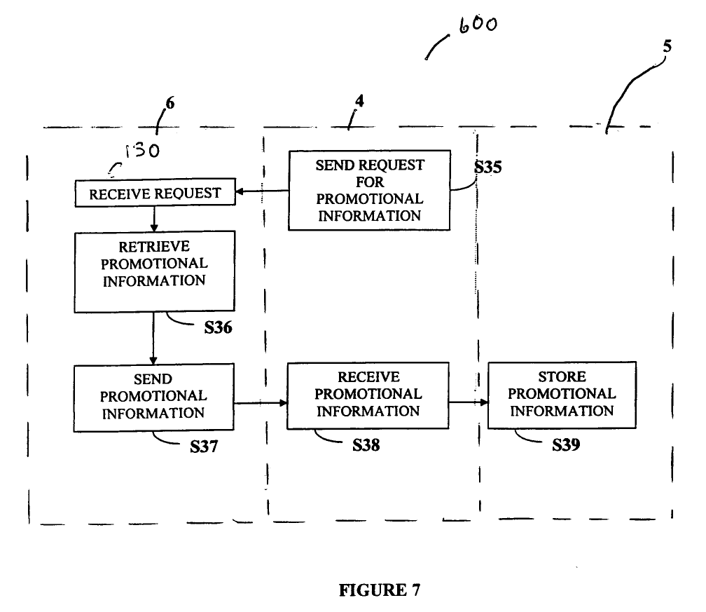

In FIG. 7, promotional information is transferred and delivered from vendor server 6 to the management information server 4 through the internet 8. In step S35, management information server 4 sends a request for promotional information to vendor server 6. Upon receiving 130 such request, vendor server 6 retrieves such promotional information from a data store and sends such information to management information server 4. Such promotional information is delivered in the form of web pages, ftp files, electronic mail, batch files and any data format capable of being transferred through a data network. In step S38, such promotional information is received and subsequently stored on database 5.

The promotional information can be manually keyed into the management information server 4 and subsequently stored on database 5.

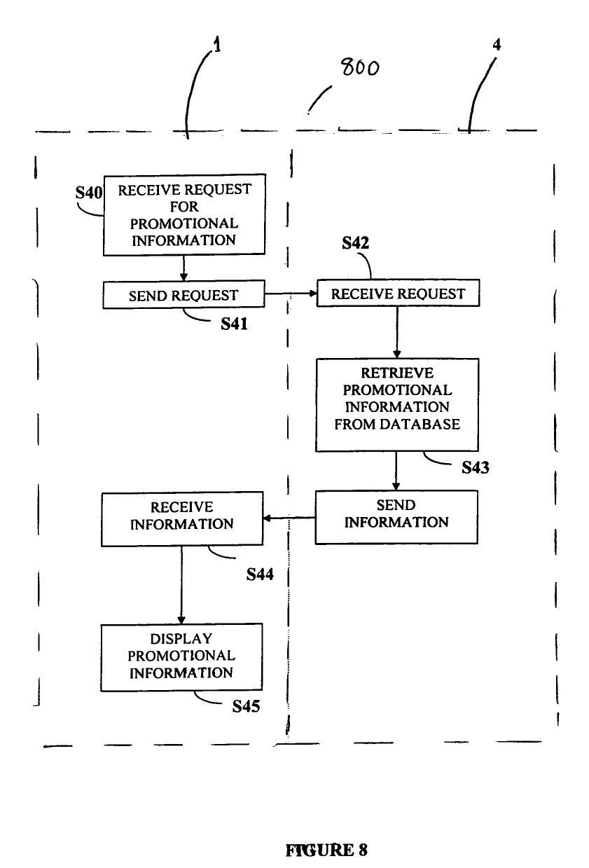

FIG. 8 shows a method 800 for retrieving and displaying promotional information. In step S40, a request for promotional information is sent to management information server 4 by store terminal 1. In a further embodiment, such request is sent by network interfacing device 7.

Upon receipt of such request in step S42, management information server 4 retrieves requested promotional information from database 5 and sends such information to store terminal 1. In a further embodiment, such information is sent from management information server 4 to network interfacing device 7. Subsequently, such promotional information is displayed to customer.

In a further embodiment, management information server 4 sends promotional information which is particular and relevant to the goods/services and promotional offers provided by the particular store in which the requesting store terminal 1 is located. For example, a store terminal located in a store selling branded shoes at a ten percent discount can retrieve information detailing which model of shoes are being sold at the discount.

In a further embodiment, management information server 4 sends promotional information which is particular and relevant to the location of said store terminal 1.

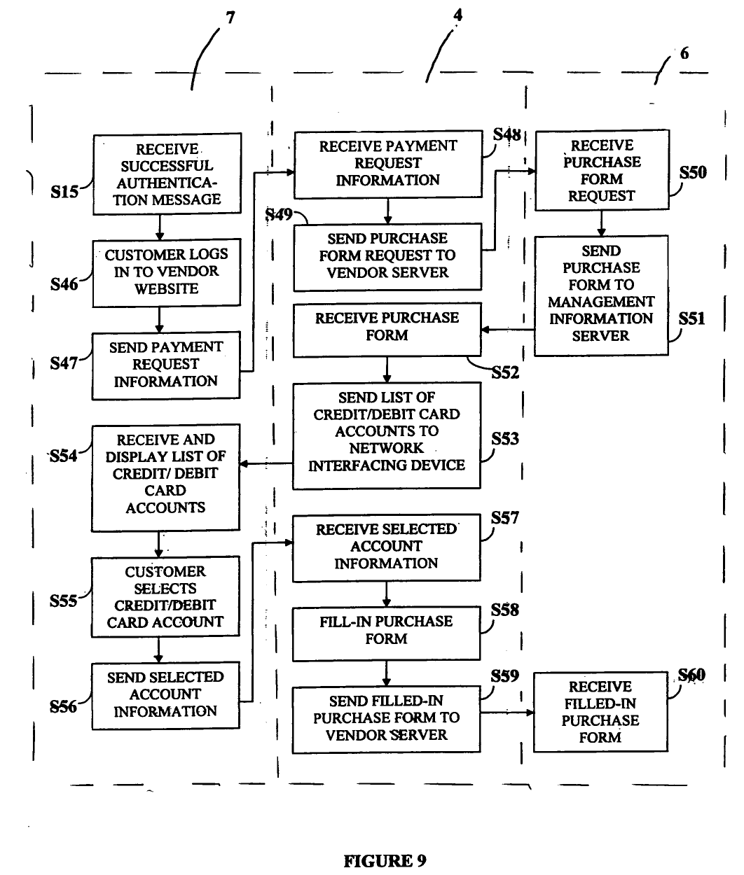

FIG. 9 is a flow diagram showing a method for automatically filling in a purchase form with customer information and credit/debit card information.

In step S15, network interfacing device 7 receives a successful authentication message from management information server 4. In step S46, the customer then logs in to a vendor website, such website offering goods/services which may be purchased by the customer. When the customer wants to make a purchase, the customer selects the goods/services for purchase and the respective quantity for purchase and any other information as required by the vendor website. In step S47, network interfacing device 7 then sends payment request information to management information server 4, such payment request information includes the goods/services for purchase, the respective quantity and the price of the goods/services for purchase. Payment request information is received by management information server 4 and a purchase form request is sent to and received by vendor server 6 in steps S49 and S50 respectively. The vendor server then sends appropriate purchase form to said management information server in step S51.

Subsequent to receiving the purchase form, management information server 4 sends a list of the customer's credit/debit card accounts to network interfacing device 7. The list of credit/debit card accounts is received by network interfacing device 7 and is displayed to the customer in step S54. Without the need for having any credit/debit cards physically present, the customer then selects a single credit/debit card account to be used in the purchase transaction in step S55, and in step S56, information pertaining to the selected credit/debit card account is sent to management information server 4. After receiving the selected account information, management information server 4 automatically fills in the purchase form with all required information. This is done by matching the required fields of the purchase form with the appropriate and respective customer information and credit/debit card information already stored on database 5. In steps S59 and S60, the purchase form with requisite customer information, credit/debit card information and purchase information is sent to and received by vendor server 6.

What is claimed is:

1. A system for making a payment transaction by using a unique customer identity number and selecting a single credit/debit card account to be used in said payment transaction from a plurality of credit/debit card accounts without requiring the use of a corresponding credit/debit card, comprising:
a store terminal
a card server
a management information server
a means for storing credit/debit card accounts information and said unique customer identity number on a storage device including a database, and for retrieving said credit/debit card account information and said unique customer identity number from said storage device,
a means for entry of unique customer identity number by a user of the system, and performing authentication of said entry,
a means for selecting said credit/debit card account from a plurality of credit/debit card accounts by displaying said plurality of card accounts and requiring a credit/debit card account to be selected, and
a means for making payment transactions using said selected credit/debit card account.

2. The system according to claim 1, further comprising a network-interfacing device, including a computer and terminal, connected to said management information server through a network, wherein
said network interfacing device includes means for retrieving, amending and storing credit/debit card account information pertaining to said plurality of card accounts,
said network interfacing device includes means for retrieving transaction history relating to said plurality of card accounts, and
said network interfacing device includes means for retrieving promotional information.

3. The system according to claim 1, further comprising a vendor server, including a computer, connected to said management information server through a network, wherein
said vendor server includes a means for sending promotional information on goods and services to said management information server, and
said management information server includes a means for storing said promotional information on goods and services and sending said promotional information to store terminal.

4. The system according to claim 2 further comprising a means for automatically filling in a purchase form with customer information and credit/debit card information.

5. A cardless method of conducting financial transactions including the steps of;
storing a unique customer identification code on a database;
associating a plurality of financial accounts with said unique customer identification code;
providing access to said plurality of financial accounts through a terminal;
validating, with a management information server, a second code entered at said terminal as matching said unique customer identification code;
upon a match occurring providing access from said terminal to said plurality of financial accounts;
receiving from said terminal information indicating a selection of one preferred account from said plurality of financial accounts;
filling in a purchase order form;
sending said purchase order form to a vendor to complete a financial transaction using said preferred account.

6. The method of claim 5 wherein the step of filling in a purchase order form includes said management information server downloading said purchase order form from a vendor site and automatically filling out said purchase order form.

7. The method of claim 5 further including the step of downloading a transaction history from said management information server through the Internet to said terminal and wherein said financial account can be accessed using a card instead of said customer identification code.

8. The method of claim 5 including the step of downloading promotional information from a vendor through an Internet to said terminal.

9. The method of claim 5 wherein said terminal is a terminal located in a store.

10. The method of claim 5 wherein said terminal is a network interfacing device.

11. The step of claim 5 including the step of a card server sending a transaction success notice to said terminal after completion of said financial transaction.

12. A cardless method of conducting financial transactions including the steps of;
storing a unique customer identification code on a database;
associating a plurality of financial accounts with said unique customer identification code;
providing access to said plurality of financial accounts through a terminal;
validating, with a management information server, a second code entered at said terminal as matching said unique customer identification code;
upon a match occurring providing access from said terminal to said plurality of financial accounts;
receiving from said terminal information indicating a selection of one preferred account from said plurality of financial accounts;
sending a purchase order form to a vendor to complete a financial transaction using said preferred account,
downloading said purchase order form from said vendor site.

13. The method of claim 12 including the step of downloading promotional information from a vendor through a network to said terminal.

14. The method of claim 13 further including the step of downloading a transaction history from said management information server through a network to said terminal.

15. The step of claim 14 wherein said financial account is a credit card account and including the step of a card server sending a transaction success notice to said terminal after completion of said financial transaction.

16. The method of claim 15 wherein said terminal is a network interfacing device.

17. The method of claim 15 wherein said terminal is a store terminal.

18. The method of claim 15 wherein said financial account is one of a credit card account, a debit card account, or a point card.
